(19) United States
(12) Patent Application Publication
(10) Pub. No.: US 2006/0198484 A1
(43) Pub. Date: Sep. 7, 2006

(54) Propulsion motor

(76) Inventor: Jose Da Conceicao, Rio de Janeiro (BR)

Correspondence Address: TRASK BRITT, P.O. BOX 2550, SALT LAKE CITY, UT, 84110, US

(21) Appl. No.: 11/324,544

(22) Filed: Jan. 3, 2006

Related U.S. Application Data
(63) Continuation-in-part of application No. 10/528,225, filed on Oct. 31, 2005.

(30) Foreign Application Priority Data
Jan. 3, 2005 (BR) C10205584-8

(51) Int. Cl. H05H 1/22

(52) U.S. Cl. 376/100

(57) ABSTRACT

Propulsion motor—a combination was added to the motor and processes, which comprises: a refrigeration system to first wall (13) constituted of tubes (13A) for conduction of refrigerator fluid, the heat exchanger (13B), the fluid storage container (13C) and inside the suction and injection fluid pump (13D). Many targets (1) were added mainly for fast ignition and many beams (4) which can execute the ignition of this targets inside reactor room (16) or inside exhaust (13, 14, 15), wherein the more simple is the explosion of a boosted micro bomb (1) direct in the center of exhaust (13, 14, 15) initiated by laser or radio frequency (3) through methods of explosive micro lenses of high explosives or super high nanostructured explosives. The hydraulic pressure system (15A, 15B, 15C) was included to maintain the magnets (15) together due to mechanical stress, and new materials to form the sheets and tubes involved. The high flow compression generator (8A, 8B, 8C, 8D, 8E) was added to generate currents and magnetic fields applied to z-pinch system, MTF and similar to explode a target (7) by fission, fusion or boosted to generate the energetic beam (4) of the fast ignition.

### CROSS REFERENCE TO RELATED APPLICATIONS

This application is a continuation-in-part of application Ser. No. 10/528,225 filed on Mar. 27, 2003, pending, which claimed priority from Brazilian application no. C10205584-8 filed on Jan. 3, 2005, pending, each of which are incorporated herein by reference.

### BACKGROUND OF THE INVENTION

It is an improvement in the motor and processes, directed to energetic beams to initiate fission and fusion nuclear reactions to produce a laser, and therefore the modifications in the target to provide explosions near 0,0001 ton TNT. The novelty provides a greater conviction due to the recently discovered physical properties, such as long time duration and stable nuclear isomers, wherein the bombarding methods of these substances were recently in their infancy, to produce a gamma-ray or x-ray laser and, therewith, to reduce the intensity of nuclear reactions (>0,0001 ton TNT), or by nuclear fission reactors wherein a hollow cylindrical tube is put (optical fiber radiation resistant), which will receive the impact of neutron flow from nuclear fission reactor kernel. Another novelty is the photon fission from photon nuclear reaction that nuclear products are neutrons or gamma-ray able to initiate photon fission reactions which, in turn, produces fission fragments that can be directed to long time duration stable nuclear isomer.

With metallic hydrogen and due to its high specific energy estimated to be 175 kJ/g, and with nuclear isomers, which used in a chemical bomb (or like a bomb) has sufficient energy to initiate a boosted micro fusion reaction (>0,1 ton TNT) by explosive micro lenses method cited in the previous application, but direct in the exhaust to propel 150 ton of mass for experimental probe.

In the previous application Ser. No. 10/528,225 to make the beams by nuclear explosions bombarding, materials like aluminum and gold are used, but the nuclear isomers of hafnium and tantalum makes this job in a better way.

The previous application Ser. No. 10/528,225 refers to the fission reactors, but does not refer to nuclear isomers placed in the local of neutron flow impact. Another inventions mention the fission reactor to produce the laser but the elements are others and they do not produce the expected result, or work with high criticality (pulsed reactors).

No targets were created in the previous application directed to the case of fission fusion fast ignition to laser generation if CPA laser does not have sufficient intensity and need micro explosions to laser generation.

Another problem in the previous application refers to exhaust vessel wherein, in the first wall a refrigerator layer is needed for this wall due to the neutrons from nuclear reactions and in the constitution of some elements from exhaust vessel (nanostructured materials, such as steel and carbon-carbon).

The present invention is intended to solve these problems, wherein the more simple solution, initiate the fusion micro reactions direct in the exhaust by chemical explosions and metallic hydrogen as chemical explosive in the micro lenses of super high explosive constitution (high explosives nanostructured), or using nuclear isomers Hf and Ta in these bombs, or to be bombarded by many processes and incrusted in the own fuel targets forming the laser inside the target and inside the exhaust, according to methods, beams and targets of the present invention.

Another solution is the laser cited in the previous application Ser. No. 10/528,225, from outside exhaust, with the methods and targets of the present invention, a micro nuclear bomb (>0,0001 ton TNT) inside a capsule having cylindrical rods of ^{178m}Hf to laser generation.

In 1999 the gamma-ray laser was achieved by the element Hf nuclear isomer to be hit by x-ray flow of 50 mA from dentist instrument. In the end of 2003 nuclear isomer bombarding was considered to be in the beginning.

In 2002 was proposed in the before application the laser bombarding by micro fission or fusion explosions (>0,001 ton TNT) using materials such as gold, aluminum and tantalum. This permits the present invention with the same lasers, but with materials such as nuclear isomers, reducing the energy produced in the explosions under 0,001 ton TNT equivalent realized today by hydronuclear tests needed to generate the x-rays (scaling if necessary) producing energy in the order of ten MJ needed to hit (bombarding) the nuclear isomers and activating the excitation energy, forming the laser (nuclear pumped nuclear isomer laser) and with minimum gain of 60, in the experimence of dentist x-rays instrument, producing laser of order of hundred MJ and these explosions are easily contained in a light weight laboratory vessel.

Another embodiment of this method is by fast ignition, where the compression phase is distinct from ignition phase, where laser and particle beams make the nuclear fuel target compression, since it is direct in the exhaust vessel, and another type of fuel compression would be expensive and a CPA laser for bombarding a nuclear isomer and forming the x-ray laser incrusted in terminal part of the ignition cone wherein 1 mmg of Ta has energy density of 0,5 MJ/mmg, and the Hf 1.2 MJ/mmg or the energy excitation is 2.5 MeV per nucleon and by direct illumination. By indirect illumination, the ignition cone of the CPA laser would be placed perpendicular to target center or parallel according to target configuration to hit the nuclear isomer in quantity of mmg, forming the laser since the CPA lasers are capable to initiate nuclear photon reactions in gold ¹⁹⁷Au(γ,n)¹⁹⁶Au, in copper ⁶⁵Cu(γ,n)⁶⁴Cu such as in another elements, in experiments analog to the “nuclear physics with ultra intense laser” where the target can be composed from gold and uranium, and the neutrons in the MeV range from nuclear photon reactions in the gold can bombard nuclear isomers Hf and Ta, or by photon induced nuclear fission ²³⁸U(γ,f) which produces 1.7 MeV of γ radiation wherein the threshold energy of γ-photon to induce fission is near 5 MeV. The uranium layer can be changed by Hf or Ta nuclear isomer, to be hit by neutrons of photon nuclear reactions or after the ²³⁸U, or ²³²Th layers, to use the γ-ray and fission fragments of high energy. Other possible method to bombard nuclear isomer is by anti protons and anti particles direct in the target exhaust with exawatt lasers, since the above values are obtained with the actual CPA laser of order of 10¹⁹ to 10²¹ w/cm², i.e., with petta watt laser. Here the proposal is to use electrons, neutrons and protons to excite γ-rays or nuclear photon reactions which produce neutrons and after photon fission to induce more radiation or a laser. With these intensities making this laser hit with the first target shell of tantalum, electrons are produced with 10 to 100 MeV of energy, which after hitting a second shell of tantalum more thick, produce γ-rays in 1/30 MeV range by Bremstrahlung by CPA laser electrons and then hit a thin target of uranium and produce γ-ray from fission or fission fragments which has threshold about 5 MeV sufficient to induce excitation of Hf or Ta nuclear isomer laser near 2.5 MeV. Bombarding gold or aluminum target with a laser in the intensities cited before produces neutrons between 10 and 100 MeV by photon nuclear reaction where the threshold is near 8 MeV in uranium or thorium which compete with γ-rays to induce photon fission whose threshold is 5 MeV, which by turn, are sufficient to excite the laser threshold energy of Hf or Ta nuclear isomer, which as before, is 2.5 about MeV. It should be noticed that with CPA laser intensities near 10²⁵ to 10²⁶ w/cm² or exawatt laser, calculations show that 10¹⁰ electrons has energy between 10 and 100 TeV after hitting Ta or Au target generating γ-rays between hundred of MeV to GeV and thereby hit ²³⁸U or ²³²Th and has fission fragments with 160 MeV enough to excite a nuclear isomer laser or the fusion ignition in a fast ignition scheme, besides that, above 140 MeV is the threshold of pair formation and with this obtain up to 10¹⁴ nuclear excitations to bombard U or Th or to form nuclear isomer lasers.

With the development of nanotechnology and the construction of nanostructured high explosives, or with technology of sol-gel, it is possible to reduce the spaces between element molecules which constitute high explosives in its matrix (C60, N60, etc) originating super high explosives which comprises metallic hydrogen or nuclear Hf or Ta isomers producing x-rays which fuse DT. Super high explosives are made of nanostructured C60, etc., where in the outer shell of the explosive micro lenses, explosives are used (based on group N₃, AgN₃, PbN₃, MgN₃) detonated by mJ laser, which in turn, detonate high explosives, but direct in the exhaust, needing the reactor room to place there the maximum number of mJ laserz to obtain the greater symmetry in the explosions, or replaced by mirrors in the reactor room. Since there are four reactor rooms around of external structure, two or three in some cases can be used to put lasers that will compress the target in most cases, and one or two rooms for the fast ignition laser (by micro explosions, z-pinch, laser, etc).

The direct exhaust systems such as above have the advantage to eliminate U/Pu explosions to make the energetic beam out of exhaust, because in this case the beam is part of the target, eliminating the need of massive reactor room contention vessel of fissions explosions, thus avoiding radioactivity.

However, with the laser produced out of exhaust using a reactor vessel or micro fission and fusion explosions vessel of contention (>0,001 ton TNT), it is possible to obtain greater intensities to bombard long life nuclear isomers and obtain photo fission, pair formation and fission fragments with 190 MeV to form the laser beam, if necessary, and by many processes in the reactor or reaction vessel to compress and form the target, by direct and indirect attack.

In the beginning of 80 decade, some laboratories speculate about the nuclear bombarding laser by neutron flow or fission fragments in nuclear fission reactors, which hit uranium hexafluoride or hydrogen fluoride gas with a low gain. In the end of 80 decade, aerosol was used in dead gas particles such as the laser medium and in the 2000 year with this model was used to invent a propulsion fusion laser in the USA.

In this embodiment of the present invention, it is proposed that the cylindrical tubes are made of nuclear isomers to be hit by a neutron flow or fission fragments from the reactor kernel, whereby so high criticality values are not necessary, although they are pulsed fission reactors. With the neutron flow estimated to be in 10¹⁴ to 10¹⁵ neutrons/cm³, it is possible to provide laser energy intensities from 5 to 50 MJ with a gain between 100 and 1000 with each neutron having 100 or 1000 MeV of energy.

Another method refers to low intensity nuclear explosions such as in hydronuclear tests (to obtain x-rays) to bombard nuclear isomers with explosions from 1 kg to 4 kg TNT equivalent making lasers from 5 to 50 MJ of energy. The nuclear isomers can be used as a tamper in a low yield nuclear bomb (>0,0001 ton TNT) to stimulate x-rays production or as a tamper in zero yield hydronuclear tests, only to x-rays production in cylindrical or spherical geometry.

Nowadays, a further intense source of x-rays is z-pinch system, for example, the utilization of the z-pinch RTL to construct a space propulsion motor the problem resides on the long length of transmission lines, since the explosions are enough to vaporize transmission line material. In a reactor, for high gain, the transmission line should have a reasonable length, but not to make low explosions, in which case there is no interest in the gain, but in enough x-rays emissions to bombard Hf and Ta nuclear isomers. Therefore, the most adequate target model is dynamic holhaum, of reduced length in the transmission lines, wherein the feed may be carried out by a capacitor bank or by high flow compression generator, where a low quantity of high explosives are used to compress a current loop or to remove turns from a coil (by explosion) containing a magnetic field thereby inducing an increase in current and magnetic field. Using magnetic fields produced by these generators, which can explode a hollow metallic cylinder, containing inside a short transmission line made of Pu or Th. A less explosive solution and which spends less material to evaporate is the metallic cylinder linked to low mass transmission line (LMTL) linked, in turn, to fixed transmission lines which may be a magnetic insulated transmission line (MITL) linked to a capacitor bank. With these methods (high flow compression generator and hollow metallic cylinder), it is possible to obtain currents from hundred of MA and magnetic fields in the order of 3000 Teslas needed to compress a hollow metallic cylinder constituted of Pu/Th (0,03 g) and DT in the center of this configuration.

If it is opted to use a CPA laser >10¹⁹ w/s and thereby form an external neutron generator, bombarding with this laser a plate or a cylindrical tube or sphere of DT or DLi6 to generate 10¹⁵ neutrons or more, or a neutron gun and then to promote a micro fission after compressed (imploded) by any processes since in this order of magnitude, a neutron insertion is necessary and thereby to control the nuclear yield, and the process is named “fast neutron insertion in micro fission”.

It is also valid in cylindrical geometry, wherein the compressor may be, by any means and having as neutron internal generator DT or DLi6, bombarded by CPA laser placed in the gold cone of fast ignition.

A particular case is the cylindrical or spherical compression of a U/Pu layer where the compression temperature is 1 keV generating a 33 Mbar pressure enough to implode DT, producing neutrons in the process. Assuming this pressure in Pu micro sphere compatible with initial density of 4590 g/cm³. To avoid natural expansion of micro sphere before nuclear ignition or chain fission reaction from occurring fully (with significant burn of Pu, U, Th), it a micro mass of DT is necessary and to furnish, after fusion and implosion of system in the exact moment of maximum criticality, the neutrons needed to ignition and the fast propagation of chain fission reaction in the micro fissile mass. Since it refers to a boosted process, it is possible to include a layer of ²⁴²Pu or ²⁴⁰Pu or ²³⁸U, since the most probable pre-ignition in this case, instead of constituting a problem would be well seen, eliminating the need for a time synchronized neutron external source.

The problem of hydrodynamic instability in DT interface with fission mass due to density difference can be solved using a layer of Li or plastic (CH) before DT layer, and wherein the explosion symmetry is solved by laser compression or magnetic field in cylindrical geometry.

The DT needed in micro fission mass is justified by the neutron number historic with time, in the search by direct attack with laser achieved 10¹⁴ neutrons in 1995 and in 2003 achieved 10¹⁵ neutrons with fast ignition methods, this suggests the presented models, since in the fast ignition, there is the relaxing in the implosions symmetry and the problem of difference in the density is solved with a layer of lithium or plastic, bearing in mind that with 10¹⁴ or 10¹⁵ neutrons, near 47 or 52 generations or doublings can be generated and nuclear yield can be controlled by the controlled neutron insertion and that 1 mmg of DT can generate 10¹⁷ neutrons. The advantage of this system compared to the antiproton fast ignition, is that it is easier and cheaper to produce neutrons than antiprotons.

An example is the calculation of micro sphere implosion of Pu(Th) with or without a cover of Be and with 1 μg of DT (R=0,001 cm) in the Pu(Th) center where the initial temperature and density are as follows:

DT: ρ=2630 g/cm³; T=5 keV; Pu: ρ=4590 g/cm³; T=1 keV (p=33 Mbar) Be: ρ=2490 g/cm³; T=1 keV; ΔR=0,005 cm

Some results from simulation:

ΔR=0,0: M_{Pu}=0,03 g; Eᵢ580 kJ; k_{ef}=1.239; α=10¹⁰/s; E=0,003 ton TNT

ΔR=0,005; M_{Pu}=0,015 g; Eᵢ=740 kJ; k_{ef}=1.570; α=10¹⁰/s; E=0,008 ton TNT.

In the level of explosions sustained by laboratory container limited to 3 GJ.

Magnetic systems are solely intended to generate the laser out of exhaust system, or the explosions would be greater to vaporize the long transmission lines. To compress Pu/U, the magnetic filed pressure obey the equation p=2 nkT with said obtaining methods and the plasma magnetic field equation is H₀²/8π=2 nkT.

The nuclear isomers which produce the laser with mass near 1 mmg may be placed in front of a CPA laser and generate the laser isomer by placing laser materials in the tip of the gold cone of fast ignition after compressing the external layer by any processes (laser, magnetic field, z-pinch, High Explosive) both in cylindrical or spherical geometry by direct or indirect illumination.

If it is problematic to retain nuclear explosions of very low yield (>0,00001 ton TNT) to make the laser in spherical and cylindrical geometry, the option is the hemispherical vessel of contention of explosions opened to vacuum as in FIG. 6 of previous case (Ser. No. 10/528,225).

For first wall exhaust protection is necessary to add a refrigerator shield due to radiations from each micro explosion, which constitute hollow cylindrical tubes to transport the refrigerator liquid, whereby the storage liquid container of the fluid pump of suction and injection and the heat exchanger are needed which is the basic refrigerator system. If in the exhaust, magnetic fields greater than 10 T are needed, a hydraulic system is necessary to sustain the coils firmly together due to stresses and own magnetic field in these intensities. Where the tubes or sheets are made of nanostructured steel or carbon-carbon, there is a greater resistance to high pressure.

### BRIEF DESCRIPTION OF SEVERAL VIEWS OF THE DRAWINGS

The invention will be better understood with the following detailed description in consonance with the appended drawings.

FIG. 1 shows a micro bomb target (>0,1 ton TNT) from super high explosives to detonate DT direct in the exhaust.

FIG. 2 shows a target to direct attack in the exhaust by fast ignition.

FIG. 3 shows a target to direct attack in the exhaust by double fast ignition generating two times more neutrons expected to fission U/Pu after being compressed.

FIG. 4 shows a target to indirect attack in the exhaust by fast ignition.

FIG. 5 shows a target to indirect attack in the exhaust by fast ignition.

FIG. 6 shows a target to direct attack in the exhaust by fast neutron ignition.

FIG. 7 shows a boosted micro bomb target (>0,0001 ton TNT) in the reactor room and inside a capsule containing ^{178m}Hf.

FIG. 8 shows a basic target scheme (layers) which may be hit by CPA laser showing the energy or threshold energy and radiation (particle) from each layer to form the Hf isomer laser.

FIG. 9 shows a laser scheme from ^{178m}Hf nuclear isomer or γ radiation with 3 layers used in the fast ignition cone.

FIG. 10 shows a laser scheme from ^{178m}Hf nuclear isomer or γ radiation with two layers used in the fast ignition cone.

FIG. 11 shows a U/Pu magnetic compression with or without fast ignition in DT.

FIG. 12 shows a Z-pinch scheme to implode U, Pu or Th, etc by magnetic compression by means of transmission lines and capacitor banks to feed the transmission lines.

FIG. 13 shows the z-pinch scheme, an option to current and magnetic field generation by means of high explosives which detonate, by current of the capacitor banks, the turns of magnetic field, which by means of an electrical switch, controls the electrical flow which will compress the target.

FIG. 14 shows a general view of the reduction in the processes and in the motor, the (mJ) lasers placed in the reactor room, with nuclear fuel direct in the exhaust and the refrigeration system.

FIG. 15 is a general view of the motor and processes with the beams of fast ignition laser in the reactor room and the nuclear fuel direct in the exhaust.

FIG. 16 is a general view of the motor with reactor or reaction room to form the laser by fission boosted micro explosion (>0,0001 ton TNT) by hydronuclear methods and processes.

FIG. 17 is a general view of motor with reactor or reaction room to form the laser by z-pinch, MTF and the like.

FIG. 18 is a general view of the motor with the lasers placed parallel to the exhaust, and the mirrors placed in two or three reaction room, permitting the hydraulic compression system or sheets hindered to the coils to maintain the same together.

### DETAILED DESCRIPTION OF THE INVENTION

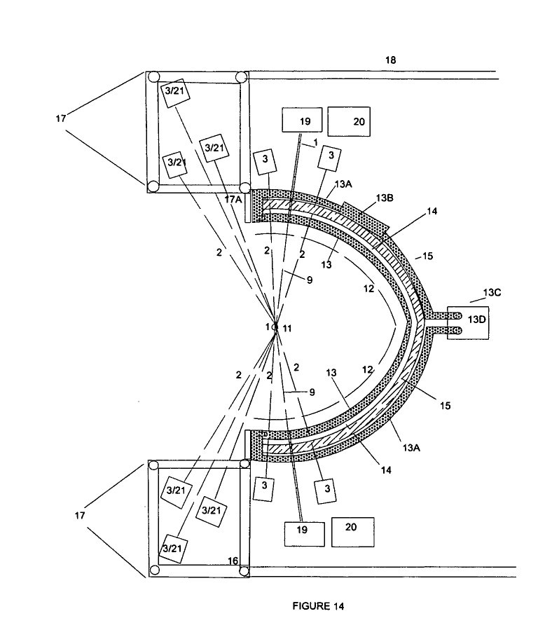

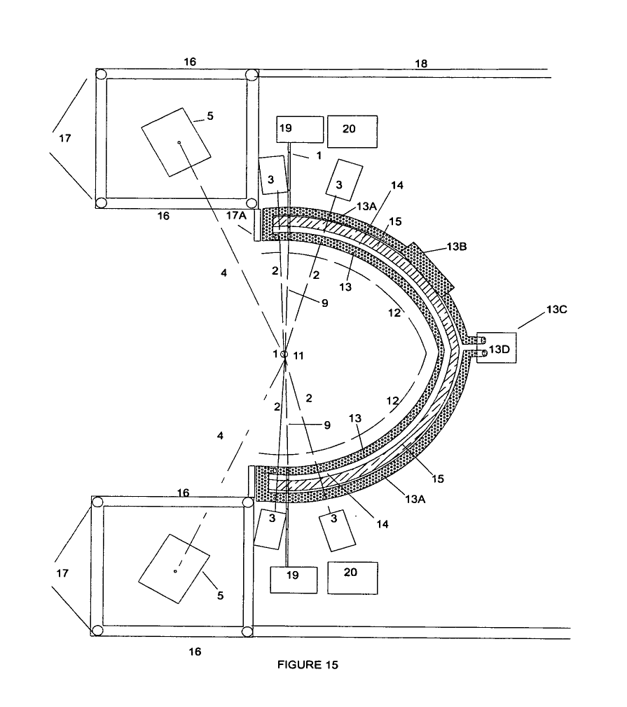

According to the drawings and details, the present invention “Propulsion Motor” has many targets (1) which are used in accordance with each presented solution. In FIG. 1, the target (1) used in FIG. 14 whose solution consists in detonate a micro bomb (>0,1 ton TNT) direct in the exhaust, constituted of layers (1A) which will form the explosive micro lenses that may be initiated by mJ laser (2) of intensity, that is, the layers of AgN₃, or PbN₃, or MgN₃, etc. to detonate nanostrucured super high explosives by sol-gel technology which reduces the internuclear spaces in the explosive matrix, which permit higher energy in the explosive. The layer (1B) constituted of metallic hydrogen whose energy density is 175 kJ/g enough to initiate U/Pu fission shield (1D), and DT fusion (1E) and thereby reduce material quantity to produce explosion, or placing the layer (1C) of tantalum or hafnium to generate x-rays and then the layers (1D) e (1E). It is the more light solution in terms of mass motor to initiate a micro fusion, since the system (3-FIG. 14) of lasers has a power in the range of mW, and easy to be obtained and installed. It will be like a NIF, but with mJ lasers.

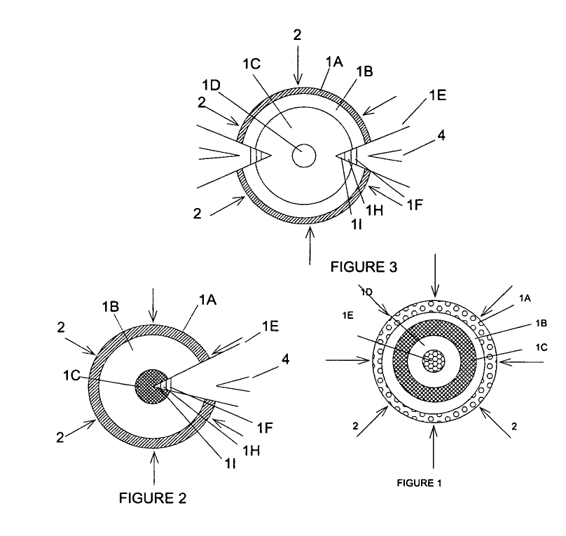

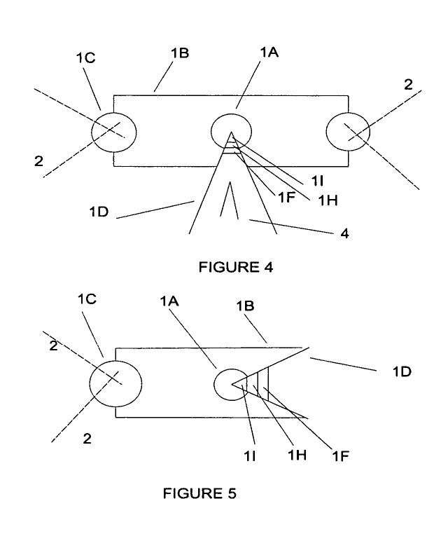

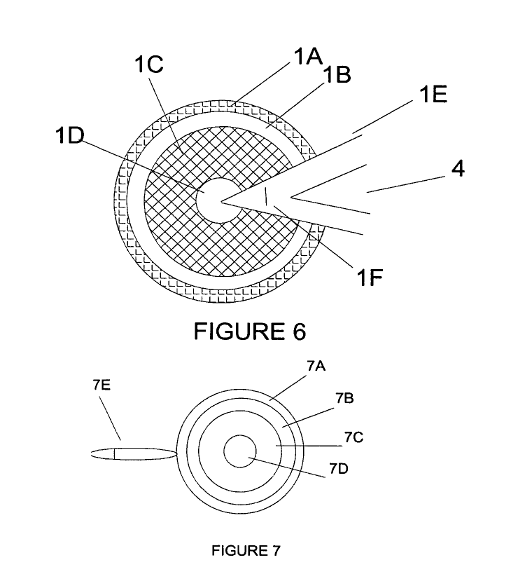

The following solution of FIG. 2 refers to the fast ignition scheme direct in the exhaust, FIG. 15, wherein the target (1) is constituted of layers (1A) of beryllium and cooper like a tamper that are hit by the beam (2) to compress the following layers of DT gas (1B) and cold DT (1C). The layer of gold or aluminum cone (1E) of fast ignition, has in its end, the layers of combinations which are obtained from FIGS. 8, 9 and 10, and are constituted of (1F) tantalum or gold according to generated particle be electrons or neutrons (1J-FIG. 9) after being hit by the beam (4) of the fast ignition system (5-FIG. 15). Then, the layers (1H) ²³⁸U or ²³²Th, wherein electrons or neutrons in collision with these layers produce photo fission or fission fragments (1L-FIG. 9) hitting with the following layer constituted of ^{178m}Hf (1) generating the Hf laser or γ-rays from Hf (1M-FIG. 9) which hit the target layer (1C) of DT initiating the fuel ignition. FIG. 3 is the same target, however with double fast ignition (4) and the central layer (1D) in the place of cold DT, U/Pu, wherein the double fast ignition (4) generates two times more neutrons than expected (10¹⁵ neutrons) after (1M-FIG. 9) hit (1C). In FIGS. 4 and 5, there are the targets for indirect attack by fast ignition inside exhaust. In FIG. 6, the layers are the same of FIG. 3, but a CPA laser (4) >10¹⁹ W/cm² hits a DT or DLi6 sheet (1F) generating 10¹⁵ neutrons which can react with the U/Pu layer (1D) in the moment of maximum compression. These systems, corresponding to FIG. 15, are criticized to be very weighty due to laser system (3,5), but they may be compact, and along the time, they may become competitive.

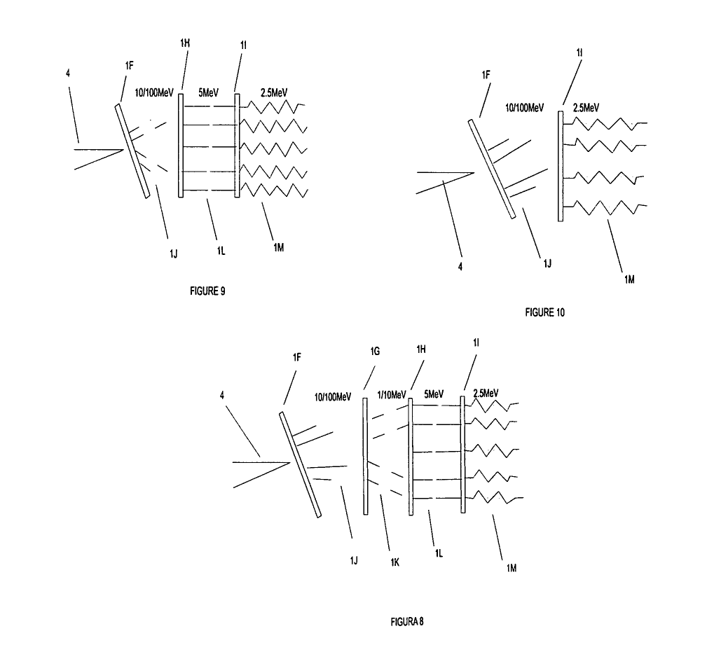

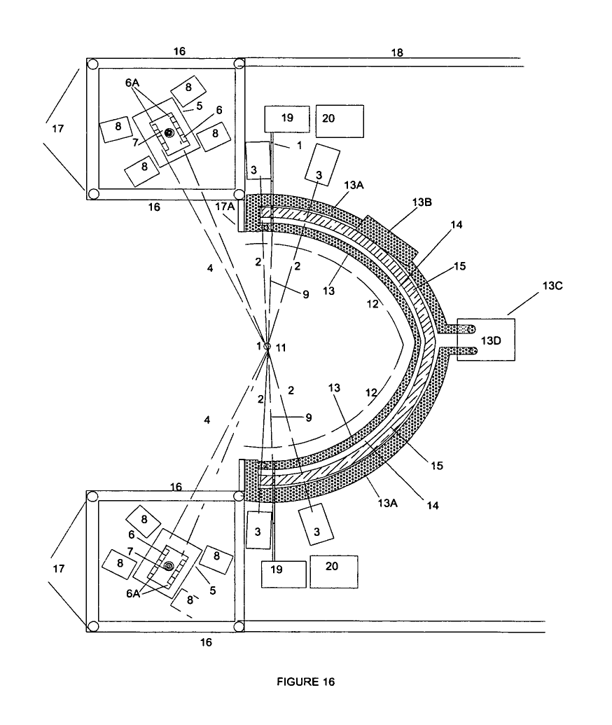

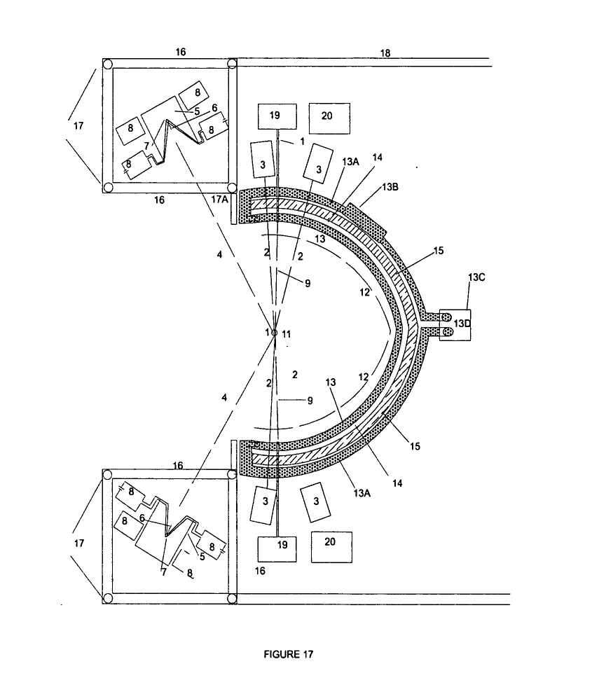

In FIG. 7, the target is shown which is constituted of a boosted micro bomb (7) (>0,0001 ton TNT) in the reactor or reaction room (16) as in FIG. 16 placed inside a capsule (6) containing the nuclear isomer ^{178m}Hf (6A). The layer (7A) is constituted of explosive micro lenses with AgN₃ or PbN₃ or MgN₃, which is detonated by mJ laser or radio frequency detonating after the high explosives or super high explosives. The layer (7B) is the neutron reflector constituted of beryllium, layer (7C) is ²³⁹Pu and the layer (7D) is DT. The layer (7E) refers to the neutron initiator or neutron gun (common in primary) of modern low dimensions warheads.

In FIG. 8, there is the option of layers used in cone (1E) of FIGS. 2, 3 and 6 placed one after another being the basic system, where the sheet (1F) is constituted of thin tantalum and after impact of CPA laser (4) generating the electrons (1J) with energies between 10 and 100 MeV which hit the plate or layer (1G) of tantalum, however more thicker, generating γ-rays (1K) in the order of 10 to 30 MeV which hit the following shell of U/Th (1H) generating the γ-rays and fission fragments or photon fission whose threshold is 5 MeV that is twice the excitation threshold of Hf laser (1I) that is 2.5 MeV, sufficient to trigger nuclear isomer Hf laser in the DT center compressed in FIGS. 2, 4 and 5 for ignition of fuel (1).

In FIG. 9, in the place of tantalum in the layer (1F), there is gold which generates neutrons (1J) by photon nuclear reactions in the gold, whose threshold energy is near 8.5 MeV, which hit the following layer (plate) constituted of U/Th (1H) whose threshold for photon fission (1L) or fission fragments is 5 MeV as before, which are sufficient to excite Hf (1I) whose threshold energy is 2.5 MeV generating the Hf nuclear isomer laser (1M) or γ-rays of Hf in the center of compressed DT, as the targets of FIGS. 2, 4 and 5 for the ignition of fuel (1).

In FIG. 10, depending on the energy of neutrons energy from CPA laser hit with Au, there is no need of the U/Th layer, and since in fission reactor, neutrons flow with energy above 2.5 MeV the nuclear isomer Hf γ-ray laser is triggered inside vicinity of the target (1).

It should be noticed that in FIGS. 8, 9 and 10 when the intensity of CPA laser (4) is near 10²⁵ to 10²⁶ W/cm², the electrons or neutrons energy (1J) is between 10 and 100 TeV after crossing the tantalum layer or gold (1F) generating γ-rays up to 10 GeV (1K) after crossing through the tantalum layer (1G) more thick and considering that above 140 MeV is the threshold for pair formation, that contributes with more energy for the following shell which may be U/Th (1H) or Hf (1I) of nuclear isomer forming a powerful ^{178m}Hf laser in the center of DT compressed by the beam (2).

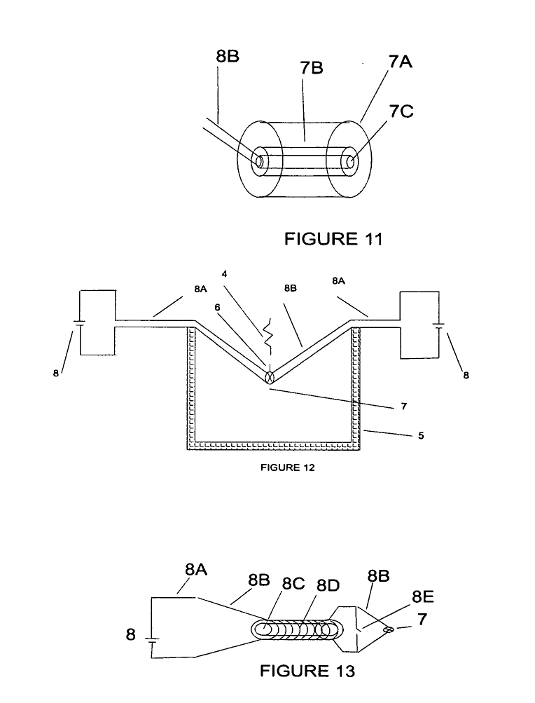

In FIG. 11, there is the target (7) to form the beam (4) in the reactor (16) as in FIG. 16 adapted to z-pinch system (5,6,7,8) FIG. 12, in this case, the recyclable transmission lines (8B) are linked to (7A) and (7C) FIG. 11 to supply the magnetic field that will compress the layer of U/Pu (7B) near 300 T, which may be obtained by a capacitor bank (8-FIG. 12) or by the current and magnetic field generator with high explosive armature (8,8A,8B,8C,8D, 8E-FIG. 13) which can reach currents with hundreds of MA and 3000 T of magnetic field, linked to a fixed transmission line (8A). An electrical option of fast ignition through a current generated by a capacitor bank (8) flowing through fixed transmission lines (8A) and recyclable transmission line (8B) that hit DT (7C) center producing the maximum compression and using another current of hundreds of MA by the high flow compression generator (8, 8A, 8B, 8C, 8D, 8E) beginning the ignition of nuclear fuel.

In FIG. 12, there is the 2 to 3 meters container (5) to retain the micro explosions (>0,0001 ton TNT) from target (7) obtained by electrical current from capacitor bank (8) to transmit this current across a fixed transmission line (8A) electrically linked to a recyclable transmission line (8B) that is vaporized after micro explosion hitting a hollow cylindrical rod (6) of the stable nuclear isomer Hf of long time duration generating the γ-ray laser (4) from Hf or Ta (Tantalum).

In FIG. 13, there is the option of the high flow compression generator, which may be used as a source of current and magnetic field composed of a capacitor bank (8) generating the current that flows along fixed transmission line (8A) that is linked to the recyclable transmission line (8B) and will detonate the high explosive (8C) which, when exploding the current line (8D), will generate more current in (8E) that is the switch that is kept closed and then discharges hundreds of MA and a magnetic field of 3000 T enough to detonate U/Pu or DT as in hollow disk of FIG. 11 and inside container (5) of FIG. 12.

In FIG. 14, regarding the previous application, a general view of the motor that supports the explosions in respect to targets of FIG. 1, wherein the laser system (3) which generates the beam (2) is of mJ of intensity. It is possible to verify the simplification in the motor according to this solution, since the laser system (3) is light and simple to configure around the target (1) placed in reactor room (16) as well as the refrigeration system where (13A) tubes are to fluid flow that will be refrigerated after crossing the heat exchanges (13B) and flowing to fluid storage tank (13C) and replaced in the first wall by fluid pump (13D) that it is the basic system for FIGS. 15,16,17, and 18, as it can be noticed.

In FIG. 15, in the part regarding the previous application, a general view of the motor that will support explosions in respect to the targets of FIGS. 2, 3, 4, 5 and 6 wherein the laser system (3,5) is needed, one (3) to compress the target (1) by beam (2) and another to fast ignition placed in reactor room (16), by beam (4), CPA laser above 10²⁵ W/cm², which was added compared to FIG. 14.

In FIG. 16, there is, compared to the previous application, a general view of motor and reactor room (16), in which case, the fast ignition is obtained by a very low boosted fission explosion target (7-FIG. 7) by the actual hydronuclear tests methods with intensities above 100 g TNT equivalent (0,0001 ton T-NT) which may be retained in vessels from 2 to 3 meters in diameter weighting 5 ton of mass, that is reasonable for a 150 ton of mass prototype.

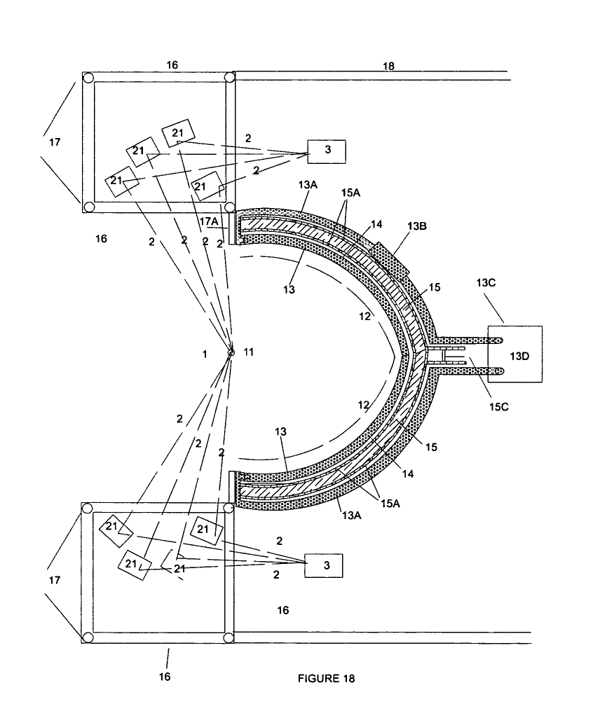

In FIG. 17 a general view of the motor and reactor room (16) is shown adapted to z-pinch to generate the laser (4) of nuclear isomer that consist of a laser system (3) to compress the target (1) and a z-pinch system (5) constituted of a capacitor bank (8) which generates current near ten of MA transported by the fixed transmission lines (8A) electrically linked to the recyclable transmission lines (8B) inside reaction vessel (5) of 2 to 3 meters in inner diameter or by high flow compression generator (8-FIG. 13) to obtain hundreds of MA and 3000 T of magnetic field sufficient to detonate U, Pu, Th and DT and with these micro explosions with a cylinder of nuclear isomer Hf (6) placed in the end of the target (7), the ^{178m}Hf laser (4) directed to target (1) is produced. It is the third more light solution in mass in the beams (3,5).

In FIG. 18, there is a general view of motor and processes where two or three reaction rooms (16) are used in compression processes of target (1) by mirrors (21) which are hit by beams (2) from laser gun (3) placed parallel to exhaust (13,14,15), permitting the placement of a nanostructured sheet of steel or carbon (15A) and tied parallel to magnets (15) in all extension to remain together due to mechanic stress caused by own magnetic field above 10 T, or by steel or carbon nanostructured tubes (15A) and inside the magnets (15), a fluid (15B) not represented in figure, which is compressed by a hydraulic system (15C) to maintain the magnets (15) together due to stress.

This system is valid (substituted) in all methods applied in FIGS. 14, 15, 16 and 17 since it is needed to avoid the stress of the magnetic field (12) and above near 10 T.

What is claimed is:

1. Propulsion motor, as defined in the application Ser. No. 10/528,225, wherein the motor is constituted of two cylindrical tubes (17) fixed between each other by cylindrical supports of sustentation (18) and a third cylindrical tube (17A) that will sustain the reaction room (16) being the set fixed to exhaust (13, 14, 15) of hemispherical shape, and the trigger system (3) placed behind magnets (15) and in reactor room (16), the present motor characterized by the first wall (13) constituted of nanostructured carbon-carbon, refrigerated by a cylindrical tubes system (13A) which flows in the wall (13) and to a heat exchanger (13B) and to a storage container (13C) and to a pump of suction and injection (13D).

2. Propulsion motor, according to claim 1, characterized by holding inside the reaction room (16) a z-pinch system (5, 6, 7, 8) to form the nuclear isomer laser (4).

3. Propulsion motor, according claim 1, characterized by having a nanostructured sheet of steel (15A) around all extension of magnets (15) and tied in order to maintain the same together.

4. Propulsion motor, according claim 1, characterized by having a nanostructured sheet of carbon (15A) around all extension of magnets (15) and tied in order to maintain the same together.

5. Propulsion motor, according to claim 1, characterized by having a nanostructured tube of carbon (15A) containing a fluid (15B) and the magnets (15), a hydraulic compression system (15C) to maintain the same together.

6. Propulsion motor, according claim 1, characterized by providing a CPA laser system (5) to fast ignition, placed in the reaction room (16) in quantities according each target (1).

7. Propulsion motor, according claim 1, characterized by having a laser system (3) placed parallel to exhaust cup (13, 14, 15) in respect to the horizontal axis, generating the beam (2) which reach mirrors (21) placed in the reaction room (16) directing the beams (2) to the target (1).

8. Processes and beams of thermonuclear fusion micro reactions, characterized by a laser driver system (3) to compress the target (1), by means of the beam (2), a trigger energetic system (5) such as fast ignition by the beam (4) generated by the cylindrical tube of nuclear isomer (6) from micro explosions of the target (7) initiated by the system (8).

9. Processes and beams from thermonuclear fusion micro reactions, according claim 8, characterized by having a laser trigger system (3) with detonator beam (2) from mJ of intensity for the target (1).

10. Processes and beams from thermonuclear fusion micro reactions, according to claim 8, characterized by having an energetic trigger system (3) to compress the target (1), by means of the beam (2), an energetic trigger system (5) such as a CPA laser, which generates the beam (4) that produces the ignition of target fuel (1).

11. Processes and beams from thermonuclear fusion micro reactions, according claim 8, characterized by having an energetic trigger system (3) to compress the target (1), by means of the beam (2), an energetic trigger system (5) obtained from a small nuclear explosion between 0,0001 to 0,02 ton TNT equivalent in the reaction room (16) and inside reaction vessel (5) which hits the capsule (6) of nuclear isomer (6A) to generate the beam (4) initiated by radio frequency (8) that produces the ignition of the target (7).

12. Processes and beams from thermonuclear fusion micro reactions, according claim 8, characterized by having an energetic trigger system (3) to compress the target (1) by means of the beam (2), an energetic trigger system (5) obtained from a small nuclear explosion near 0,0001 to 0,02 ton TNT equivalent inside the reaction room (16) and inside reaction vessel (5) which hits the capsule (6) of nuclear isomer (6A) to generate the beam (4) initiated by laser (8) from mJ of intensity, and explode the high explosive and ignition of target (7).

13. Processes and beams from thermonuclear fusion micro reactions, according claim 8, characterized by having an energetic trigger system (3) to compress the target (1) through the beam (2), an energetic trigger system (5) obtained from small nuclear explosions near 0,0001 to 0,02 ton TNT equivalent in the reaction room (16) that hit the cylinder of nuclear isomer (6,6A) obtained from a z-pinch system (5,6,7,8) to generate the beam (4) initiated by a current from the capacitor bank (8,8A,8B) to explode the target (7).

14. Processes and beams from thermonuclear fusion micro reactions, according claim 8, characterized by having an energetic trigger system (3) to compress the target (1) by means of the beam (2), an energetic trigger system (5) obtained from a small nuclear explosion near 0,0001 to 0,02 ton TNT equivalent in the reaction room (16) which hits the cylinder of nuclear isomer (6,6A) obtained from a z-pinch system (5,6,7,8) to generate the beam (4) initiated by a current from high flow compression generator (8,8A,8B,8C, 8D,8E) to explode the target (7).

15. Processes and beams from thermonuclear fusion micro reactions, according claim 8, characterized by having the target (1) constituted of layers (1A) of super high nanostructured explosives, metallic hydrogen (1B), tantalum (1C), U/Pu (1D) and DT (1E), exploded direct in the exhaust (13,14,15) by laser (3).

16. Processes and beams from thermonuclear fusion micro reactions, according claim 8, characterized by having the target (1) constituted of layers (1A) Be+Cu, DT gas (1B), solid DT (1C), gold cone of fast ignition (1E), constituted of layers in the tip cone (1F) of tantalum, (1H) from U/Th, (1I) of ^{178m}Hf stable nuclear isomer.

17. Processes and beams from thermonuclear fusion micro reactions, according claim 8, characterized by having the target (1) constituted of layers (1A) Be+Cu, DT gas (1B), solid DT (1C), U/Pu (1D) two gold cone of fast ignition (1E) constituted of layers (1F) tantalum, (1H) U/Th, (1I) ^{178m}Hf stable nuclear isomer.

18. Processes and beams from thermonuclear fusion micro reactions, according claim 8, characterized by having the target (1) constituted of layers (1A) DT fuel, holhaum (hollow cylinder) (1B) with double entrance hole (1C) and in the hollow cylinder (1B) the gold cone of fast ignition (1D) constituted of layers (1F) tantalum, (1H) U/Th, (1I) ^{178m}Hf stable nuclear isomer.

19. Processes and beams from thermonuclear fusion micro reactions, according claim 8, characterized by having the target (1) constituted of layers (1A) DT fuel, holhaum (hollow cylinder) (1B) with only one entrance hole (1C) for the hollow cylinder (1B), gold cone of fast ignition (1D) constituted of layers (1F) tantalum, (1H) U/Th, (1I) ^{178m}Hf stable nuclear isomer.

20. Processes and beams from thermonuclear fusion micro reactions, according claim 8, characterized by having the target (1) constituted of layers (1A) Be+Cu, (1B) solid DT, (1C) DT gas, (1D) U/Pu (1E) gold cone of fast ignition, (1F) neutron generator constituted of a sheet of DT/DLi6 coupled to the opened part of gold cone (1E) hit by a CPA laser.

21. Processes and beams from thermonuclear fusion micro reactions, according claim 8, characterized by having the target (7) constituted of layers (7A) explosive micro lenses constituted of AgN₃, PbN₃, which detonate high explosives, (7B) beryllium, (7C) U/Pu, (7D) DT, (7E) neutron generator.

22. Processes and beams from thermonuclear fusion micro reactions, according claim 8, characterized by having the target (7) constituted of hollow cylinder (7A), inside this cylinder, a thin cylinder of U/Pu containing a cylinder of DT (7C) electrically linked to a recyclable transmission line (8B) in both sides of the hollow cylinder (7A) which has this current transported to another fixed transmission line (8A).
